(19) United States
(12) Patent Application Publication
(10) Pub. No.: US 2019/0301676 A1
(43) Pub. Date: Oct. 3, 2019

(54) HIGH PRESSURE CONTAINER

(71) Applicant: TOYOTA JIDOSHA KABUSHIKI KAISHA, Toyota-shi (JP)

(72) Inventor: Osamu SAWAI, Okazaki-shi (JP)

(73) Assignee: TOYOTA JIDOSHA KABUSHIKI KAISHA, Toyota-shi (JP)

(21) Appl. No.: 16/260,811

(22) Filed: Jan. 29, 2019

(30) Foreign Application Priority Data
Mar. 29, 2018 (JP) 2018-065253

(51) Int. Cl. F17C 1/02; F17C 1/00; F17C 1/14

(52) U.S. Cl. CPC F17C 1/02; F17C 1/005; F17C 2205/0308; F17C 2203/0604; F17C 2201/0109; F17C 1/14

(57) ABSTRACT

Reinforcement layers are each formed in a belt shape set with a smaller width than a diameter dimension of a container body. Each reinforcement layer has its length direction along an axial direction of the container body and spans between one axial direction side end and another axial direction side end of the container body, including at caps. Moreover, the reinforcement layers span across the caps and the container body at locations other than maximum diameter portions, these being locations where the diameter dimensions of the cap and the container body are greatest in a direction orthogonal to a direction of adjacency of the container body with other container bodies as viewed along the axial direction.

### CROSS-REFERENCE TO RELATED APPLICATION

This application is based on and claims priority under 35 USC 119 from Japanese Patent Application No. 2018-065253 filed on Mar. 29, 2018, the disclosure of which is incorporated by reference herein.

### BACKGROUND

### Technical Field

The present disclosure relates to a high pressure container.

### Related Art

Japanese Patent Application Laid-Open (JP-A) No. 2002-188794 discloses an example of a high pressure hydrogen tank. This high pressure hydrogen tank is configured including a barrel-shaped liner and a reinforcement layer configured by fiber reinforced plastic wrapped around the liner. This configuration raises the rigidity of the liner, enabling hydrogen to be stored at high pressure therein.

However, this high pressure hydrogen tank has a large barrel shape, which could reduce the amount of cabin space or the amount of luggage space in a vehicle to which the high pressure hydrogen tank is installed. Namely, efficient utilization of space in the vehicle might not be possible. Disposing plural tanks with a diameter small enough that they can be disposed side-by-side in an available space in the vehicle may be considered as a potential solution to this issue. However, providing plural tanks necessitates a reinforcement layer for each tank, and it is possible that securing the space equivalent to the reinforcement layers might impinge on the cabin space or luggage space. There is accordingly room for improvement with regards to efficient vehicle space utilization.

### SUMMARY

The present disclosure obtains a high pressure container enabling efficient vehicle space utilization.

A high pressure container according to a first aspect includes plural container bodies, caps, and reinforcement layers. Each container body is formed in a circular cylinder shape with an opening at least at one axial direction side end, and the plural container bodies is disposed adjacent to each other in a radial direction. The caps are each formed in a substantially circular column shape having an axis in a same direction as an axial direction of a corresponding container body, and each of which closes off a respective opening of one of the plural container bodies. The reinforcement layers are each formed in a belt shape narrower in width than a diameter dimension of a respective container body and with a length direction running along the axial direction of the container body such that the reinforcement layer spans between the one axial direction side end and another axial direction side end of the container body including at the cap. Each reinforcement layer spans across the respective cap and the respective container body at a position other than at a maximum diameter portion at a location corresponding to an orthogonal-radial direction orthogonal to a direction of adjacency to another of the container bodies.

According to the first aspect, each of the container bodies is formed in a circular cylinder shape with an opening at least at one axial direction side end. Plural of the container bodies are arranged adjacent to each other in a radial direction. Accordingly, providing plural container bodies with diameters corresponding to an available space in a vehicle enables the required amount of fluid to be stored in the container bodies while keeping an effect on vehicle cabin space and luggage space to a minimum. The openings of the container bodies are closed off by the caps, and each reinforcement layer spans from the one axial direction side end to the other axial direction side end of the respective container body, including at the cap. This thereby enables the cap to be restricted from detaching from the container body when high pressure fluid is being stored in the container body.

Note that each reinforcement layer is formed in a belt shape, set with a narrower (smaller) width than the diameter dimension of the respective container body, and the reinforcement layer runs with its length direction along the axial direction of the container body (referred to hereafter simply as the “axial direction”) so as to span between the one axial direction side end and the other axial direction side end of the container body including at the cap. Each reinforcement layer spans across the respective cap and the respective container body at a position other than the maximum diameter portion at a location corresponding to the orthogonal-radial direction orthogonal to the direction of adjacency to another of the container bodies. Namely, the reinforcement layers can be provided within spaces that arise when the circular column shaped container bodies are provided adjacent to each other in a radial direction. Accordingly, when the plural container bodies are arrayed adjacent to each other, an increase in the dimensions of the container bodies in a direction orthogonal to the direction of adjacency of the container bodies (for example, a height dimension in cases in which the container bodies are arrayed in a radial direction along a horizontal plane) caused by the reinforcement layers can be suppressed, enabling a more compact configuration.

A high pressure container according to a second aspect is the first aspect, wherein the reinforcement layers are configured including a first reinforcement layer spanning across a position other than at the maximum diameter portion as viewed along the axial direction of the container body, and a second reinforcement layer spanning across a position other than at the maximum diameter portion as viewed along the axial direction of the container body and that is also a different position from the position of the first reinforcement layer. Moreover, the first reinforcement layer and the second reinforcement layer intersect each other at the cap.

According to the second aspect, the reinforcement layers are configured including the first reinforcement layer and the second reinforcement layer. The first reinforcement layer spans across a position other than at the maximum diameter portion as viewed along the axial direction, and the second reinforcement layer spans across a position other than at the maximum diameter portion as viewed along the axial direction and that is also a different position from the position of the first reinforcement layer. The first reinforcement layer and the second reinforcement layer intersect each other at the cap. Namely, providing the plural reinforcement layers spanning across the caps so as to span across different positions to each other enables the force retaining the caps on the container bodies to be increased. This thereby enables the pressure withstanding ability to be increased.

A high pressure container according to a third aspect or a seventh aspect is the first aspect or the second aspect, wherein a pair of ribs are provided on a surface of each of the caps so as to oppose each other from both width direction sides of the reinforcement layer, the pair of ribs being formed so as to project in a substantially normal direction to a face of the reinforcement layer.

According to the third aspect or the seventh aspect, the surface of each cap is formed with the ribs of pairs provided opposing each other from both width direction sides of the reinforcement layer and projecting in the substantially normal direction to the face of the reinforcement layer. The ribs make it more difficult for the reinforcement layer to detach from the cap, enabling the force retaining the cap on the corresponding container body to be increased. Accordingly, the pressure withstanding ability of the high pressure container can be increased.

A high pressure container according to a fourth aspect or an eighth aspect is the third aspect or the seventh aspect, wherein the cap is formed with a wrapped portion around which the reinforcement layer is wrapped, the wrapped portion being formed with a location projecting in a same direction as the ribs and projecting further than the ribs.

According to the fourth aspect or the eighth aspect, the cap is formed with the wrapped portion around which the reinforcement layer is wrapped. The wrapped portion is formed with the location projecting in the same direction as the ribs and projecting further than the ribs. This facilitates assembly of the reinforcement layer to the wrapped portion and therefore to the cap, even in cases in which productivity is improved by pre-forming the reinforcement layer in a ring shape and assembling the reinforcement layer to the wrapped portion from the location projecting further than the ribs.

A high pressure container according to a fifth aspect is the first aspect, wherein at least one of the caps includes an insertion portion that is inserted into the corresponding container body, and the insertion portion is provided with packing to abut the corresponding container body.

According to the fifth aspect, the caps close off the respective container bodies and are capable of moving along the axial direction. Accordingly, the stress acting on the caps from fluid inside the container bodies can be regulated, while being balanced against stress acting on the caps from the reinforcement layers of the high pressure container.

In a high pressure container according to a sixth aspect is the first aspect, at least one of the caps includes a communication flow path that at least places a fluid stored inside the container body closed off by this cap in communication with at least one other adjacent container body and that is formed between the at least one of the caps and another cap closing off the at least one other adjacent container body.

According to the sixth aspect, the interiors of the adjacent container bodies of the high pressure container are placed in communication with each other by the communication flow path. This thereby enables the stress within the adjacent container bodies of the high pressure container to be made uniform, enabling a concentration of stress on the reinforcement layers at a portion of the high pressure container to be reduced or prevented.

The high pressure container according to the first aspect exhibits the excellent advantageous effect of enabling efficient vehicle space utilization.

The high pressure containers according to the second aspect, the third aspect, the fifth aspect, the sixth aspect, and the seventh aspect exhibit the excellent advantageous effect of enabling the amount of internally stored high pressure fluid to be increased.

The high pressure containers of the fourth aspect and the eighth aspect exhibit the excellent advantageous effect of enabling productivity to be improved.

### BRIEF DESCRIPTION OF THE DRAWINGS

Exemplary embodiments of the present invention will be described in detail based on the following figures, wherein:

FIG. 1 is a schematic perspective view illustrating part of a high pressure container according to an exemplary embodiment of the present disclosure in a state viewed from a vehicle upper side;

FIG. 2 is an enlarged front view illustrating the portion Z in FIG. 1;

FIG. 3 is an enlarged cross-section illustrating a state sectioned along line A-A in FIG. 1;

FIG. 4 is an enlarged cross-section illustrating a state sectioned along line B-B in FIG. 3; and

FIG. 5 is a schematic perspective view illustrating a cap of a high pressure container according to an exemplary embodiment of the present disclosure in a state viewed from the vehicle upper side.

### DETAILED DESCRIPTION

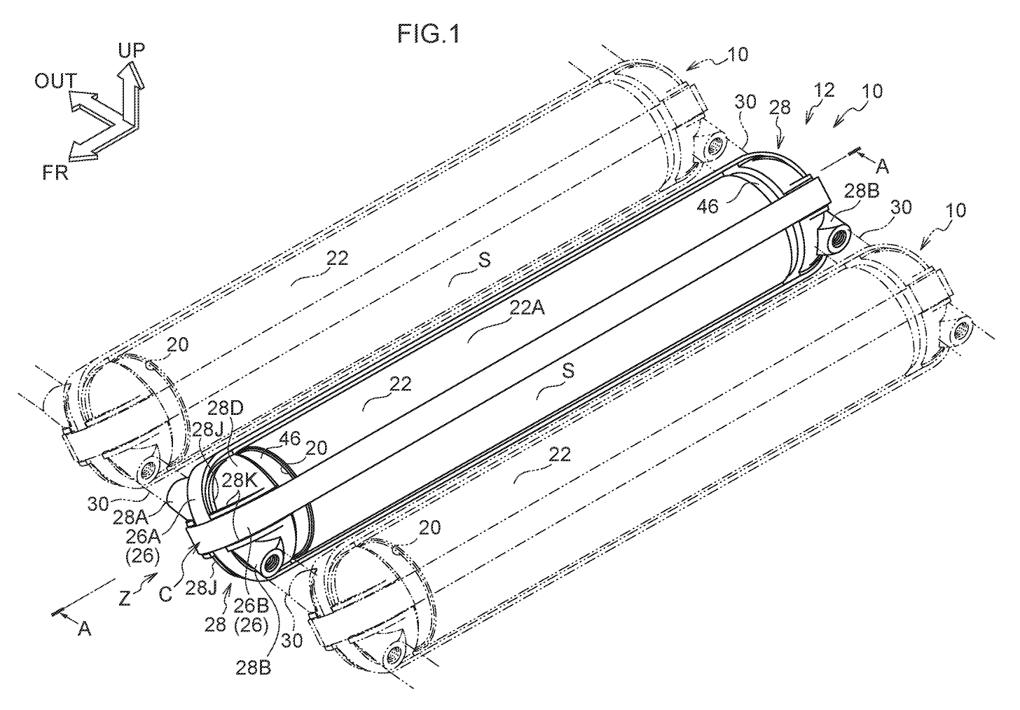

Explanation follows regarding an exemplary embodiment of a high pressure container 10 according to the present disclosure, with reference to FIG. 1 to FIG. 5. In the drawings, the arrow FR indicates a vehicle front-rear direction front side, the arrow OUT indicates a vehicle width direction outer side, and the arrow UP indicates a vehicle vertical direction upper side.

As illustrated in FIG. 1, a tank module 12 is configured by combining plural of the high pressure containers 10. Specifically, each high pressure container 10 is formed in a substantially circular column shape with its axial direction (length direction) running along the vehicle front-rear direction. Plural similarly configured high pressure containers 10 are arranged adjacent to each other along the vehicle width direction (a radial direction of the high pressure containers 10). The tank module 12 is, for example, disposed at a vehicle lower side of a floor panel (not illustrated in the drawings) of a fuel cell vehicle, and is capable of supplying hydrogen, serving as an internally stored fluid supplied from the exterior, to a fuel cell stack (not illustrated in the drawings).

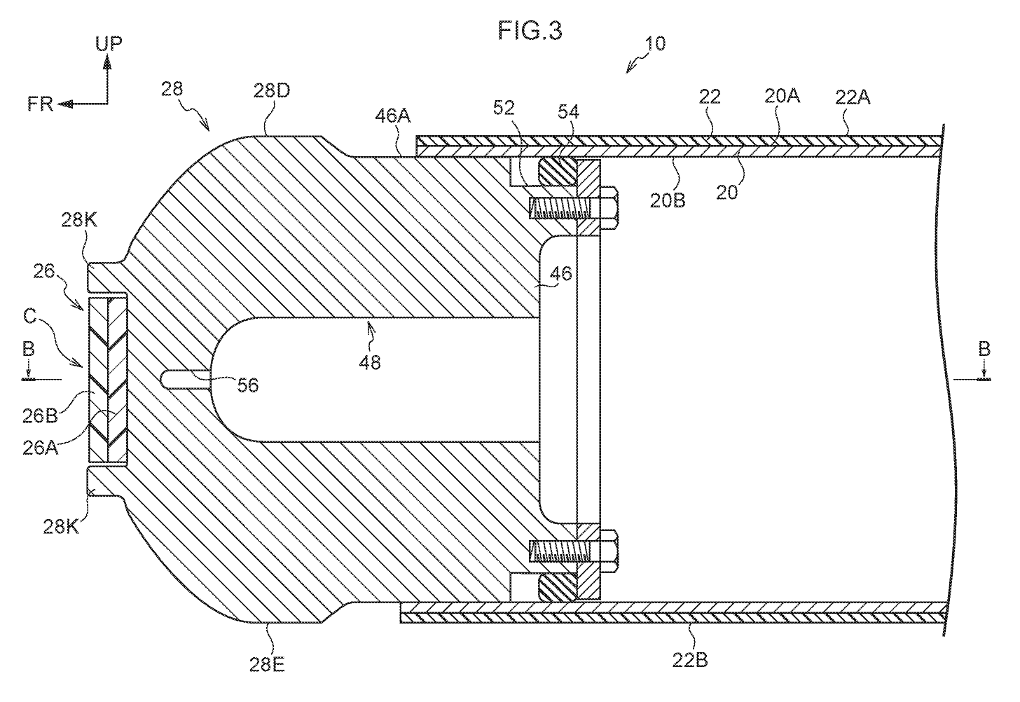

As illustrated in FIG. 3, each high pressure container 10 is configured including a container body 20, a covering member 22, and reinforcement layers 26. The container body 20 is, for example, configured from an aluminum alloy formed into a circular cylinder shape open at both axial direction ends. The container body 20 has a diameter dimension capable of being housed in an available space at the vehicle lower side of the floor panel.

The covering member 22 is configured by wrapping a carbon fiber reinforced plastic (CFRP) sheet around an outer circumferential face 20A of the container body 20. Carbon fibers, not illustrated in the drawings, within the covering member 22 are arrayed so as to predominantly follow the circumferential direction of the container body 20. In other words, the fiber direction in the covering member 22 is the circumferential direction of the container body 20.

As illustrated in FIG. 1, the container bodies 20 of the plural high pressure containers 10 are arranged adjacent to each other in the vehicle width direction with the covering member 22 wrapped around each container body 20. A cap 28 is inserted into one axial direction side (vehicle front side) end and the other axial direction side (vehicle rear side) end of each of the plural container bodies 20.

As illustrated in FIG. 3, each cap 28 has its axial direction running in the vehicle front-rear direction, and is formed in a substantially semicircular column shape protruding toward the axial direction outer side of the container body 20. Each cap 28 includes a body-inserted portion 46 and a communication flow path 48. The body-inserted portion 46 is disposed inside the container body 20 of the high pressure container 10, and is formed in a substantially circular column shape projecting toward the axial direction inner side of the container body 20. An outer circumferential face 46A of the body-inserted portion 46 abuts an inner circumferential face 20B of the container body 20. Note that the cap 28 is capable of sliding in the axial direction with respect to the container body 20, and that the cap 28 is capable of moving in the axial direction corresponding to the pressure of a fluid stored in the container body 20. This thereby enables stress acting on the cap 28 from the fluid inside the container body 20 to be regulated.

A packing housing portion 52, formed by notching an outer edge portion toward the radial direction inside, is provided at a leading end portion of the body-inserted portion 46. An O-ring 54, serving as packing, is contained in the packing housing portion 52. The O-ring 54 is elastically deformed in the radial direction of the container body 20. The body-inserted portions 46 close off the one axial direction side (vehicle front side) end and the other axial direction side (vehicle rear side) end of the container body 20.

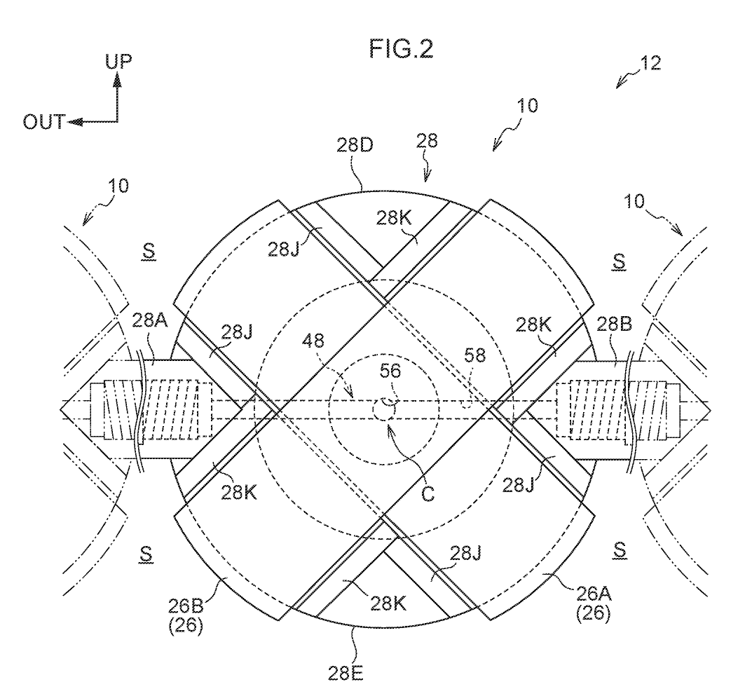

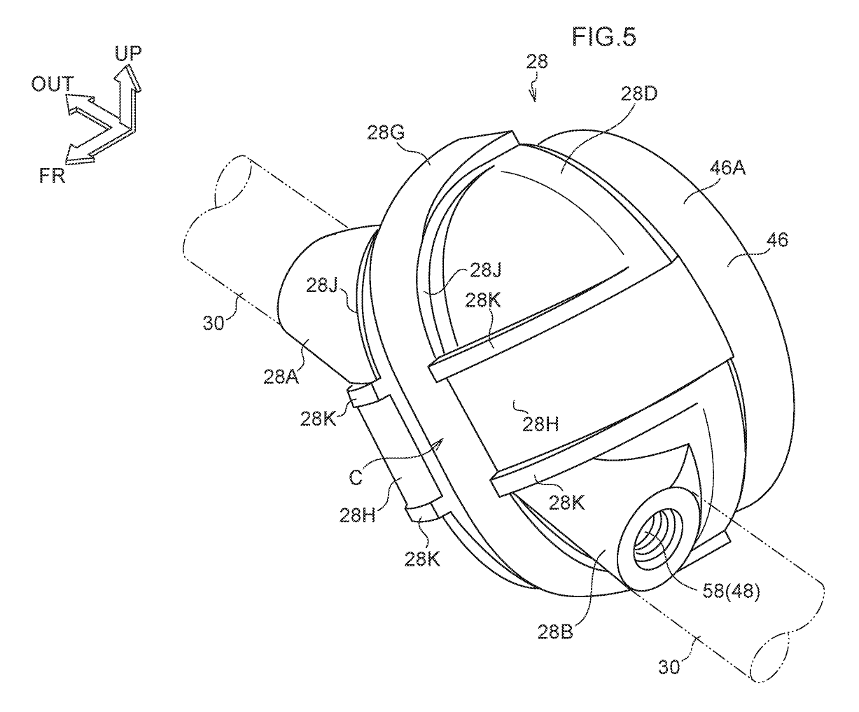

The communication flow path 48 is formed inside the cap 28. Specifically, the communication flow path 48 is configured including a first communication flow path 56 and a second communication flow path 58 (see FIG. 2). The first communication flow path 56 follows the axial direction of the container body 20 inside the body-inserted portion 46 and opens toward the axial direction inner side, and the second communication flow path 58 extends along a radial direction of the container body 20 (the vehicle width direction) and is coupled to an axial direction outer side end of the first communication flow path 56. As illustrated in FIG. 5, flow path coupling portions 28A, 28B are respectively formed at locations of the cap 28 corresponding to the second communication flow path 58. The flow path coupling portions 28A, 28B are internally threaded, enabling tube-shaped coupling tubes 30 to be fastened thereto. The coupling tubes 30 couple the flow path coupling portions 28A, 28B to flow path coupling portions 28A, 28B in caps 28 of other adjacent high pressure containers 10. The interiors of the container bodies 20 of plural adjacent high pressure containers 10 are thus placed in communication with each other through the first communication flow paths 56 and the second communication flow paths 58.

As illustrated in FIG. 1, the reinforcement layers 26 include a first reinforcement layer 26A and a second reinforcement layer 26B. The first reinforcement layer 26A and the second reinforcement layer 26B are both provided spanning across an outer face of the covering member 22 of the container body 20 and an outer face of the pair of caps 28. Each reinforcement layer 26 is configured from belt shaped (sheet shaped) carbon fiber reinforced plastic (CFRP), similarly to the covering member 22. Each reinforcement layer 26 is formed in a ring shape with a width direction dimension of the reinforcement layer 26 set smaller than the diameter dimension of the container body 20. Moreover, the reinforcement layers 26 span across the axial direction of the container body 20 (covering member 22) and the caps 28, at positions excluding maximum diameter portions 22A, 22B, 28D, 28E (see FIG. 3), these being locations corresponding to an orthogonal-radial direction (the vehicle vertical direction) orthogonal to the direction of adjacency between the container body 20 of the high pressure container 10 and the container bodies 20 of other high pressure containers 10 (orthogonal to the vehicle width direction). Specifically, as illustrated in FIG. 2, the first reinforcement layer 26A spans across each cap 28 from between the maximum diameter portion 28D and the flow path coupling portion 28A to between the maximum diameter portion 28E and the flow path coupling portion 28B.

The second reinforcement layer 26B spans across each cap 28 from between the maximum diameter portion 28D and the flow path coupling portion 28B to between the maximum diameter portion 28E and the flow path coupling portion 28A. Namely, the first reinforcement layer 26A and the second reinforcement layer 26B span across different positions to each other. The first reinforcement layer 26A and the second reinforcement layer 26B are each disposed at positions where they do not project to the radial direction outside with respect to the maximum diameter portions 22A, 22B, 28D, 28E. In other words, a height direction dimension of the cap 28 and a height direction dimension of the container body 20 are not increased by the reinforcement layers 26.

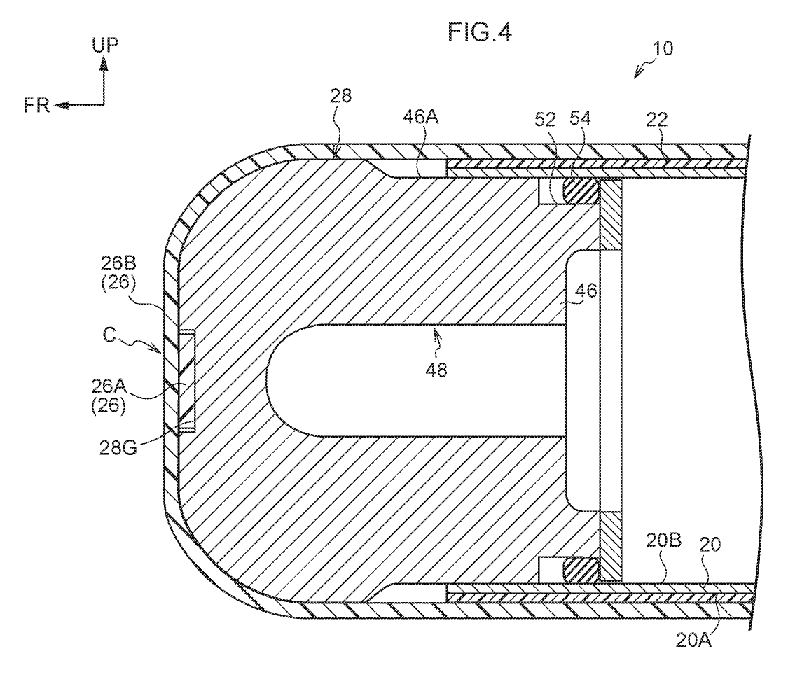

As illustrated in FIG. 5, wrapped portions 28G, 28H are formed on the surface of each cap 28 at locations spanned by the reinforcement layers 26. Specifically, the wrapped portion 28G is formed at a location spanned by the first reinforcement layer 26A, and the wrapped portion 28H is formed at a location spanned by the second reinforcement layer 26B. The wrapped portion 28H is interrupted for a distance corresponding to the width of the wrapped portion 28G at a location where the wrapped portion 28G and the wrapped portion 28H cross each other (a central portion C of each cap 28 as viewed along the axial direction). Moreover, at the location where the wrapped portion 28G and the wrapped portion 28H cross each other, the wrapped portion 28G is formed toward the axial direction inner side of the wrapped portion 28H by an amount corresponding the thickness of the first reinforcement layer 26A (see FIG. 4).

A pair of ribs 28J are formed at both width direction ends of the wrapped portion 28G on the surface of the cap 28, namely at both width direction sides of the first reinforcement layer 26A. The ribs 28J project in a substantially normal direction to the face of the first reinforcement layer 26A spanning across the wrapped portion 28G namely in the sheet thickness direction (a direction orthogonal to the surface) of the first reinforcement layer 26A. A projection amount of each rib 28J in the substantially normal direction to the face of the first reinforcement layer 26A (see FIG. 1) is configured so as to decrease on progression from the central portion C toward the radial direction outside of the cap 28. Namely, the projection amount of each rib 28J with respect to the wrapped portion 28G is greatest at the central portion C, and the projection amount of each rib 28J is smallest at the radial direction outside. A projection amount of the wrapped portion 28G becomes greater than that of the ribs 28J at the radial direction outside of the cap 28. In other words, the wrapped portion 28G includes locations that project further than the ribs 28J.

A pair of ribs 28K are similarly formed to the wrapped portion 28G at both width direction ends of the wrapped portion 28H on the surface of the cap 28, namely at both width direction sides of the second reinforcement layer 26B. Namely, the ribs 28K project in a substantially normal direction to the face of the second reinforcement layer 26B (see FIG. 1) spanning across the wrapped portion 28H. The ribs 28K are interrupted similarly to the wrapped portion 28H at the central portion C of the cap 28, and a projection amount of each rib 28K in the substantially normal direction to the face of the second reinforcement layer 26B is configured so as to decrease on progression toward the radial direction outside. Namely, the projection amount of each rib 28K with respect to the wrapped portion 28H is greatest in the vicinity of the interrupted location at the central portion C, and the projection amount of each rib 28K is smallest at the radial direction outside. A projection amount of the wrapped portion 28H becomes greater than that of the ribs 28K at the radial direction outside of the cap 28. In other words, the wrapped portion 28H includes locations that project further than the ribs 28K.

The communication flow path 48 inside each cap 28 is provided with a valve, not illustrated in the drawings, serving as a valve member, thereby enabling the rate at which fluid flows through the communication flow path 48 to be controlled using the valve. The communication flow path 48 is also connected to a fuel cell stack, supply pipe, and the like, none of which are illustrated in the drawings.

In the present exemplary embodiment, as illustrated in FIG. 1, the container body 20 is formed in a circular cylinder shape with an opening at least at one side end in its axial direction. Plural of the container bodies 20 are arranged adjacent to each other in a radial direction. Accordingly, providing plural container bodies 20 each having a diameter appropriate for an available space in the vehicle enables the required amount of fluid to be stored in the container bodies 20, while keeping the effect on vehicle cabin space and luggage space to a minimum. The openings in the container bodies 20 are closed off by the caps 28, and the reinforcement layers 26 span from one side end to the other side end of each container body 20, including at the caps 28. This thereby enables the caps 28 to be restricted from detaching from the container bodies 20 when high pressure fluid is stored in the container bodies 20.

Note that each reinforcement layer 26 is formed in a belt shape set with a narrower width than a diameter dimension of the container body 20, and the reinforcement layer 26 runs with its length direction along the axial direction of the container body 20 so as to span between the one axial direction side end and the other axial direction side end of the container body 20, including at the caps 28. The reinforcement layers 26 span across positions other than the maximum diameter portions 22A, 22B, 28D, 28E, these being the locations corresponding to the orthogonal-radial direction orthogonal to the direction of adjacency between the caps 28 and container body 20 and other container bodies 20. Namely, the reinforcement layers 26 can be provided within spaces S that arise when the circular column shaped container bodies 20 are provided adjacent to each other in a radial direction. Accordingly, when the plural container bodies 20 are arrayed adjacent to each other, an increase in the dimensions of the container bodies 20 in the direction orthogonal to the direction of adjacency between the container bodies 20 caused by the reinforcement layers 26 can be suppressed, enabling a more compact configuration.

The reinforcement layers 26 are configured including the first reinforcement layer 26A and the second reinforcement layer 26B. As viewed along the axial direction, the first reinforcement layer 26A spans across a position other than the maximum diameter portions 22A, 22B, 28D, 28E, and as viewed along the axial direction, the second reinforcement layer 26B spans across a position other than the maximum diameter portions 22A, 22B, 28D, 28E that is also a different position from the first reinforcement layer 26A. The first reinforcement layer 26A and the second reinforcement layer 26B intersect each other at the caps 28. Namely, providing the plural reinforcement layers 26 spanning across the caps 28 at different positions to each other enables the force retaining the caps 28 on the container body 20 to be increased. This thereby enables the pressure withstanding ability to be increased.

The surface of each cap 28 is formed with the ribs 28J, 28K, each provided in a pair opposing each other from both width direction sides of the corresponding reinforcement layer 26 and projecting in the substantially normal direction to the face of the corresponding reinforcement layer 26. The ribs 28J, 28K make it more difficult for the reinforcement layers 26 to detach from the caps 28, enabling the force retaining the caps 28 on the container body 20 to be further increased. Accordingly, the pressure withstanding ability of the high pressure container 10 can be increased. This thereby enables a greater amount of high pressure fluid to be stored inside the high pressure container 10.

Each cap 28 is formed with the wrapped portions 28G, 28H around which the reinforcement layers 26 are wrapped. The wrapped portions 28G, 28H are each formed with locations that project in the same directions as the ribs 28J, 28K so as to project further than the ribs 28J, 28K. This facilitates assembly of the reinforcement layers 26 to the wrapped portion 28G, 28H, and therefore to the caps 28, even in cases in which instead of wrapping the reinforcement layers 26 onto the caps 28 and the container body 20, productivity is improved by pre-forming each reinforcement layer 26 in a ring shape in a separate process and assembling the ring shaped reinforcement layers 26 to the wrapped portions 28G, 28H from the locations projecting further than the ribs 28J, 28K. This thereby enables productivity to be improved.

Note that in the exemplary embodiment described above, each container body 20 is configured from an aluminum alloy. However, there is no limitation thereto, and the container body 20 may be configured from a material that suppresses the penetration of internal hydrogen, such as a Nylon resin. Moreover, the high pressure container 10 is configured to internally house hydrogen. However, there is no limitation thereto, and the high pressure container 10 may house another gas, or may house a liquid such as LPG

Moreover, each container body 20 is open at both axial direction ends. However, there is no limitation thereto, and the container body 20 may configured in a circular cylinder shape with a bottom so as to be open at only one axial direction side end, with a cap 28 closing off the container body 20 at the one axial direction side end only.

The interiors of the plural high pressure containers 10 are placed in parallel communication with each other by the communication flow paths 48 of the caps 28 and the like. However, there is no limitation thereto, and the interiors of the plural high pressure containers 10 may be placed in communication with each other in series (a configuration in which the interiors of the respective high pressure container 10, the caps 28, the communication flow paths 48, and the like form a single meandering line in vehicle plan view).

The reinforcement layers 26 are configured including the first reinforcement layer 26A and the second reinforcement layer 26B. However, there is no limitation thereto, and a reinforcement layer may be configured by a single body, or may be configured including three or more separate reinforcement layers.

Explanation has been given regarding an exemplary embodiment of the present disclosure. However, the present disclosure is not limited to the above, and obviously various other modifications may be implemented within a range not departing from the spirit of the present disclosure.

What is claimed is:

1. A high pressure container comprising:
a plurality of container bodies, each container body being formed in a circular cylinder shape with an opening at least at one axial direction side end, and the plurality of container bodies being disposed adjacent to each other in a radial direction;
caps that are each formed in a substantially circular column shape having an axis in a same direction as an axial direction of a corresponding container body, and each of which closes off a respective opening of one of the plurality of container bodies; and
reinforcement layers that are each formed in a belt shape that is narrower in width than a diameter dimension of a respective container body and with a length direction running along the axial direction of the container body such that the reinforcement layer spans between the one axial direction side end and another axial direction side end of the container body including at the cap, and each reinforcement layer spanning across the respective cap and the respective container body at a position other than at a maximum diameter portion at a location corresponding to an orthogonal-radial direction that is orthogonal to a direction of adjacency to another of the container bodies.

2. The high pressure container of claim 1, wherein:
the reinforcement layers are configured including a first reinforcement layer spanning across a position other than at the maximum diameter portion as viewed along the axial direction of the container body, and a second reinforcement layer spanning across a position other than at the maximum diameter portion as viewed along the axial direction of the container body and that is also a different position from the position of the first reinforcement layer; and
the first reinforcement layer and the second reinforcement layer intersect each other at the cap.

3. The high pressure container of claim 1, wherein a pair of ribs are provided on a surface of each of the caps so as to oppose each other from both width direction sides of the reinforcement layer, the pair of ribs being formed so as to project in a substantially normal direction to a face of the reinforcement layer.

4. The high pressure container of claim 3, wherein the cap is formed with a wrapped portion around which the reinforcement layer is wrapped, the wrapped portion being formed with a location projecting in a same direction as the ribs and projecting further than the ribs.

5. The high pressure container of claim 1, wherein:
at least one of the caps includes an insertion portion that is inserted into the corresponding container body; and
the insertion portion is provided with packing to abut the corresponding container body.

6. The high pressure container of claim 1, wherein at least one of the caps includes a communication flow path that at least places a fluid stored inside the container body closed off by this cap in communication with at least one other adjacent container body and that is formed between the at least one of the caps and another cap closing off the at least one other adjacent container body.

7. The high pressure container of claim 2, wherein a pair of ribs are provided on a surface of each of the caps so as to oppose each other from both width direction sides of the reinforcement layer, the pair of ribs being formed so as to project in a substantially normal direction to a face of the reinforcement layer.

8. The high pressure container of claim 7, wherein the cap is formed with a wrapped portion around which the reinforcement layer is wrapped, the wrapped portion being formed with a location projecting in a same direction as the ribs and projecting further than the ribs.
